(19) United States
(12) Patent Application Publication
(10) Pub. No.: US 2015/0159540 A1
(43) Pub. Date: Jun. 11, 2015

(54) COOLING DEVICE OF MULTI-CYLINDER ENGINE

(71) Applicant: Mazda Motor Corporation, Aki-gun (JP)

(72) Inventors: Haruki Misumi, Hiroshima-shi (JP); Ryotaro Nishida, Hiroshima-shi (JP); Yusuke Marutani, Hiroshima-shi (JP); Takashi Sakumoto, Hamamatsu-shi (JP); Tomohiro Koguchi, Higashihiroshima-shi (JP)

(21) Appl. No.: 14/558,658

(22) Filed: Dec. 2, 2014

(30) Foreign Application Priority Data
Dec. 5, 2013 (JP) 2013-252253

(51) Int. Cl. F01P 7/14; F01P 5/10; F02F 1/16; F01P 3/02

(52) U.S. Cl. CPC F01P 7/14; F01P 3/02; F01P 5/10; F02F 1/16; F01P 2003/024

(57) ABSTRACT

A cooling device of a multi-cylinder engine circulates a coolant from a water pump through water jackets of a cylinder head and a cylinder block. The cooling device includes a main jacket of the water jacket of the cylinder head, formed around combustion chambers, an exhaust jacket of the water jacket of the cylinder head, communicating to the main jacket and formed on an opposite side of exhaust ports to the combustion chambers, a circulation system for suppressing that the coolant flows through the main jacket in an engine cold start, by circulating the coolant through the water pump and the exhaust jacket, and a convection suppressor for suppressing that the coolant flows into the main jacket from the water jacket of the cylinder block in the engine cold start, by suppressing a convection of the coolant inside the water jacket of the cylinder block.

### BACKGROUND

The present invention relates to a cooling device of a multi-cylinder engine, and particularly to an art, which achieves combustion stabilization in an early stage of an engine cold start.

JP5223389B discloses one example of a cooling device for circulating a coolant to respective locations of a multi-cylinder engine by using a single water pump.

The cooling device includes a circulation flow path where the coolant circulates. The circulation path has, in the following order from its upstream side, a water pump, a water jacket of a cylinder block, a water jacket of a cylinder head (upper part of exhaust manifold), a main flow path passing through a radiator and a thermostat, a first branch flow path branched from the main flow path at a position downstream of the water jackets, a second branch flow path branched from the main flow path at a position upstream of the water jackets, and a merged flow path where the first and second branch flow paths merge at a position in the upper part of an exhaust manifold and downstream of the water jackets, pass through an EGR cooler and an air-circulating heater, and communicate with the main flow path at a position between the radiator and the water pump. Further, a three-way valve is disposed at an upstream end of the merged flow path, in other words, the merging position of the first and second branch flow paths. The three-way valve is controlled to switch the connecting state among the first branch flow path, the second branch flow path, and the merged flow path.

In an early stage of an engine start, the cooling device warms up a catalyst by controlling the three-way valve to disconnect all the paths from each other and also stopping the water pump. After the catalyst is warmed up, the cooling device controls the three-way valve to connect the second branch flow path to the merged flow path, activates the water pump, flows the coolant only to the upper part of the exhaust manifold in an internal combustion engine, and further flows the coolant after passing through the upper part of the exhaust manifold, to circulate to the EGR cooler and the heater. As described above, since the cooling device stops the circulation of the coolant in the early stage of the engine start and circulates the coolant to the upper part after the catalyst is warmed up, the cooling device has an effect of increasing the temperatures of the walls of the combustion chambers in an engine cold start.

After the engine is warmed up, the cooling device controls the three-way valve to connect all the flow paths to each other so as to also flow the coolant to the cylinder block and the cylinder head in addition to the upper part of the exhaust manifold, and the cooling device suitably changes a ratio between a flow rate of the coolant flowing to the upper part of the exhaust manifold and a flow rate of the coolant flowing to the cylinder block and the cylinder head. Thereby, temperatures of the respective positions of the internal combustion engine are controlled.

However, with the cooling device of JP5223389B, when the water pump is activated and the coolant passes through the upper part of the exhaust manifold after the catalyst is warmed up, this coolant flow influences (pulls) the coolant within the respective water jackets of the cylinder head and the cylinder block, and a convection of the coolant occurs in the water jacket of the cylinder block. Further, by this convection, the coolant of the water jacket of the cylinder block enters into the water jacket of the cylinder head and flows inside the water jacket of the cylinder head. As a result, situations occur where the combustion chambers and their peripheries are cooled by the coolant flowing in the water jacket, and the wall temperatures of the combustion chambers become difficult to increase, and combustion stabilization in the early stage cannot be achieved.

### SUMMARY

The present invention is made in view of the above situations and aims to achieve combustion stabilization in an early stage of an engine cold start by suppressing a flow of a coolant inside the respective water jackets of a cylinder head and a cylinder block.

In the present invention, a suppressor for suppressing a flow of a coolant from a water jacket of a cylinder block into a water jacket of a cylinder head is provided.

Specifically, in the present invention, a cooling device of a multi-cylinder engine including a cylinder head and a cylinder block is provided. The cooling device circulates a coolant from a water pump through a water jacket of the cylinder head and a water jacket of the cylinder block. The cooling device has the following configuration.

That is, according to a first aspect of the present invention, the cooling device includes a main jacket of the water jacket of the cylinder head, formed around the combustion chambers of the engine, an exhaust jacket of the water jacket of the cylinder head, communicating to the main jacket and formed on an opposite side of the exhaust ports to the combustion chambers, a circulation system for suppressing the coolant from flowing through the main jacket in an engine cold start, by circulating the coolant through the water pump and the exhaust jacket, and a convection suppressor for suppressing the coolant from flowing into the main jacket from the water jacket of the cylinder block in the engine cold start, by suppressing the occurrence of a convection of the coolant inside the water jacket of the cylinder block.

According to this configuration, in the engine cold start, the circulation system flows the coolant only to the exhaust jacket by activating the water pump, so as to suppress the convection of the coolant inside the main jacket. The coolant within the water jacket of the cylinder block communicating to the exhaust water jacket via the main jacket may be influenced (pulled) by this coolant flow inside the exhaust jacket to cause a convection, and the coolant inside the water jacket of the cylinder block may flow into the main jacket of the cylinder head; however, the convection suppressor suppresses the convection, and thus, the coolant flow inside the main jacket is suppressed and it becomes difficult to cool the periphery of the combustion chambers. As a result, wall temperatures of the combustion chambers smoothly increase and combustion stabilization in the multi-cylinder engine can be achieved at an early stage.

With the cooling device, a coolant inlet part for introducing the coolant into a lower section of the water jacket may be formed in a cylinder block outer circumferential wall forming an outer circumference of the water jacket of the cylinder block. The convection suppressor may include a jacket spacer disposed in the water jacket of the cylinder block. The jacket spacer may have a spacer main body disposed in the water jacket of the cylinder block and surrounding all circumferences of the lower sections of a plurality of cylinder bores as a whole, a pair of flanges protruding outward from both upper and lower ends of the spacer main body, respectively, and a vertical wall extending upward from an outer circumferential end of one of the pair of flanges located higher than the other. A cutout section may be formed at a position of the upper flange near the coolant inlet part, and main communication paths communicating the water jacket of the cylinder block to the main jacket may be formed above the cutout section.

According to this configuration, the spacer main body surrounds all the circumferences of the lower sections of the cylinder bores as a whole to prevent a direct contact of the coolant with the circumferences of the lower sections of the cylinder bores. Thus, cooling of the periphery of the cylinder bores is suppressed.

Moreover, the upper flange divides the water jacket of the cylinder block into upper and lower sections, and the entrance into the periphery of the combustion chambers is suppressed against the coolant flowing inside the lower section. On the other hand, the lower flange suppresses the coolant to reach under the spacer main body, so as to prevent the coolant from flowing into a space between the spacer main body and the cylinders. Therefore, the convection of the coolant inside the water jacket of the cylinder block is suppressed.

Further, there is a possibility that a part of the coolant reaches an upper side of the upper flange and the convection of the coolant occurs in a space on the upper side, in other words, a space between the vertical wall and the cylinder block outer circumferential wall. Here, a heat transmission rate of liquid by a natural convection within a sealed space is lower as a width of the sealed space is narrower since the natural convection is suppressed. Therefore, by providing the vertical wall, the width of the space on the upper side of the upper flange is narrowed and the convection of the coolant in the space is suppressed more.

With the cooling device, openings may be formed at positions of an upper end portion of the spacer main body corresponding to inter-cylinder bore portions, respectively. An inter-bore communication passage communicating the water jacket of the cylinder block to the main jacket may be formed above each of the openings.

According to this configuration, the coolant flowing along the outer circumference of the spacer main body passes through the openings, further through the inter-bore communication passages, and flows into the main jacket of the cylinder head. While flowing to the main jacket, the coolant contacts the inter-cylinder bore portions. Therefore, even after the engine is warmed up, the inter-cylinder bore portions can be effectively cooled.

With the cooling device, the water pump, the exhaust jacket, and a heat exchanger for heater may be provided in a coolant circuit for circulating the coolant through the water pump and the exhaust jacket, and the circulation system may include the coolant circuit, and the water pump, the exhaust jacket, and the heat exchanger for heater.

According to this configuration, the coolant is heated in the exhaust jacket by high-temperature exhaust gas passing through the exhaust ports, and the heated coolant flows into the heat exchanger for the heater and heats air around the heat exchanger. Thus, the performance of the heater can be assured by utilizing the heat of the exhaust gas.

With the cooling device, the water pump may be operated by the multi-cylinder engine. The circulation system may also include a flow adjusting valve set for limiting a flow rate of the coolant as an engine speed increases when a heating operation is requested.

According to this configuration, a heat amount carried by the coolant flowing inside the coolant circuit per unit flow rate increases as the engine speed increases when a heating operation is requested, a part of the heat amount is not exchanged and only circulates through the coolant circuit, which leads to undesirable extra work for the water pump. Therefore, even if the flow rate of the coolant flowing inside the coolant circuit is limited according to the engine speed increase, the heat amount satisfying the heating operation request can be supplied to the heat exchanger for the heater, and the performance of the heater can be assured. Therefore, by using the flow adjusting valve set to limit the flow rate of the coolant flowing inside the coolant circuit according to the engine speed increase when the heating operation is requested, the workload of the water pump for circulating the coolant can be suppressed while assuring the performance of the heater, and the operation load of the engine used to operate the water pump can be reduced.

With the cooling device, the multi-cylinder engine may be a spark-ignition engine in which a compression self-ignition combustion operation is performed when an engine load is low, and a spark-ignition combustion operation is performed when the engine load is high.

According to this configuration, the convection of the coolant inside the water jacket of the cylinder block is suppressed by the convection suppressor, and thus, the compression self-ignition combustion can be stabilized in an early stage and maintained. As a result, a compression self-ignition combustion operating range can be extended and fuel consumption can be improved.

### BRIEF DESCRIPTION OF THE DRAWINGS

FIG. 1 is a schematic view illustrating a configuration of an engine cooling device according to one embodiment of the present invention.

FIG. 2 is a plan view illustrating a cylinder block of the engine.

FIG. 3 is a cross-sectional view of an engine main body in which a jacket spacer is disposed in a water jacket of the cylinder block, taken along a line III-III in FIG. 2.

FIG. 4 is a cross-sectional view of the engine main body in which the jacket spacer is disposed in the water jacket of the cylinder block, taken along a line IV-IV in FIG. 2.

FIG. 5 is an overall perspective view of the jacket spacer seen from an exhaust side.

FIG. 6 is an overall perspective view of the jacket spacer seen from an intake side.

FIG. 7A is a plan view of the jacket spacer, FIG. 7B is a side view of the jacket spacer seen from the exhaust side, FIG. 7C is a side view of the jacket spacer seen from the intake side, FIG. 7D is a front view of the jacket spacer, and FIG. 7E is a rear view of the jacket spacer.

FIG. 8 is a cross-sectional view illustrating a schematic configuration of a cylinder head of the engine.

FIG. 9 is a view illustrating a bottom face of the cylinder head with a gasket attached thereto.

FIG. 10 is a block diagram illustrating a configuration of an engine control unit.

FIG. 11 is a schematic view illustrating a flow of cooling water when a flow adjusting valve opens a first cooling water passage and closes second to fourth cooling water passages.

FIG. 12 is a schematic view illustrating the flow of cooling water when the flow adjusting valve opens the first to third cooling water passages and closes the fourth cooling water passage.

FIG. 13 is a schematic view illustrating the flow of cooling water when the flow adjusting valve opens all the first to fourth cooling water passages.

FIG. 14 is an overall perspective view of the jacket spacer seen from the intake side, according to another embodiment of the present invention.

### DETAILED DESCRIPTION OF EMBODIMENTS

Hereinafter, embodiments of the present invention are described based on the appended drawings. The following description of the preferred embodiments is essentially merely an illustration, and it is not intended to limit the scope, application and use of the present invention.

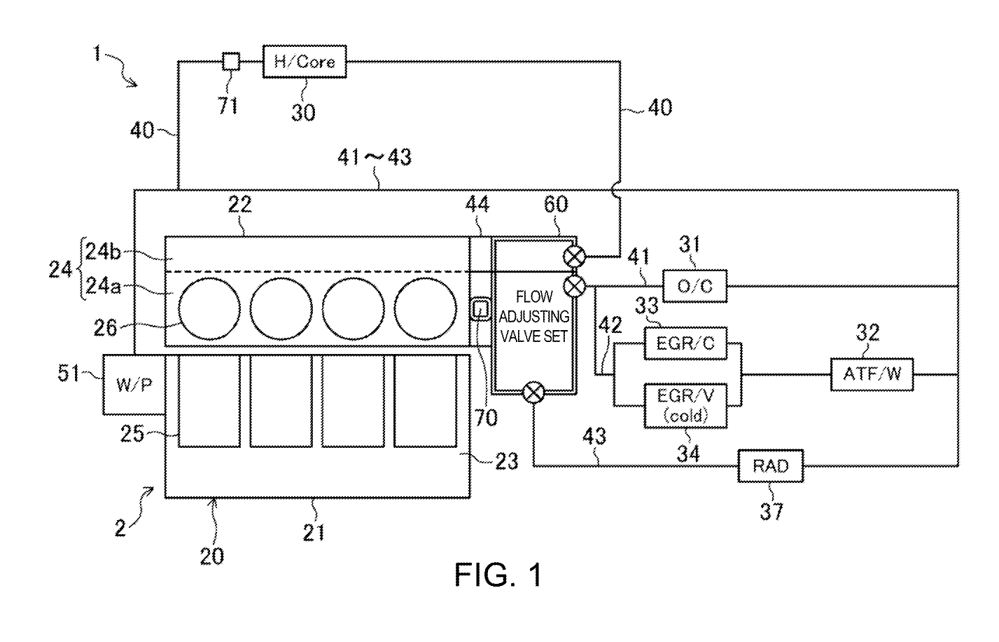

FIG. 1 is a schematic view illustrating a configuration of a cooling device 1 of a multi-cylinder engine 2 according to one embodiment of the present invention. The engine cooling device 1 includes: water jackets 23 and 24 respectively formed in a cylinder block 21 and a cylinder head 22 configuring a main body 20 of the engine 2; a heater core 30 (circulation system, heat exchanger for heater) of an air-conditioning unit disposed, for example, inside a dash board (not illustrated) to warm up the inside of (heat air inside) a vehicle by using cooling water (coolant); an oil cooler 31 for exchanging heat between oil and the cooling water; an ATF warmer 32 for heating or cooling non-illustrated transmission fluid (in this embodiment, ATF) by the cooling water; an EGR cooler 33 disposed inside an EGR passage (not illustrated) to cool exhaust gas flowing therein by the cooling water; a cold EGR valve 34 disposed inside the EGR passage to adjust a flow rate of the exhaust gas flowing therein; a radiator 37 disposed, for example, in a front part of the vehicle to cool the cooling water by using outdoor air; a first cooling water passage 40 (circulation system, coolant circuit) for circulating the cooling water through the heater core 30 to an exhaust-side jacket 24b (described later) of the water jacket 24 of the cylinder head 22; a second cooling water passage 41 for circulating the cooling water through the oil cooler 31 to the engine main body 20; a third cooling water passage 42 for circulating the cooling water through the EGR cooler 33, the EGR valve 34, and the ATF warmer 32, to the engine main body 20; a fourth cooling water passage 43 for circulating the cooling water through the radiator 37 to the engine main body 20; and a mechanical water pump 51 (circulation system, hereinafter simply referred to as the water pump) for supplying the cooling water to the water jacket 23 of the cylinder block 21.

The engine 2 is an inline four-cylinder engine in which four siamesed-type cylinders 25 are aligned along axial directions of a crankshaft (not illustrated), and also is a spark-ignition engine that performs a compression self-ignition combustion operation (CI operation) when an engine load is low, and performs a spark-ignition combustion operation (SI operation) under the following conditions: one of when the combustion is unstable during the CI operation of the engine and when the engine load is high. The engine 2 includes the cylinder block 21 made of aluminum alloy and the cylinder head 22 also made of aluminum alloy and attached to the cylinder block 21 from its upper side. Pistons (not illustrated) move up and down inside the cylinders 25 formed by the cylinder block 21 and the cylinder head 22.

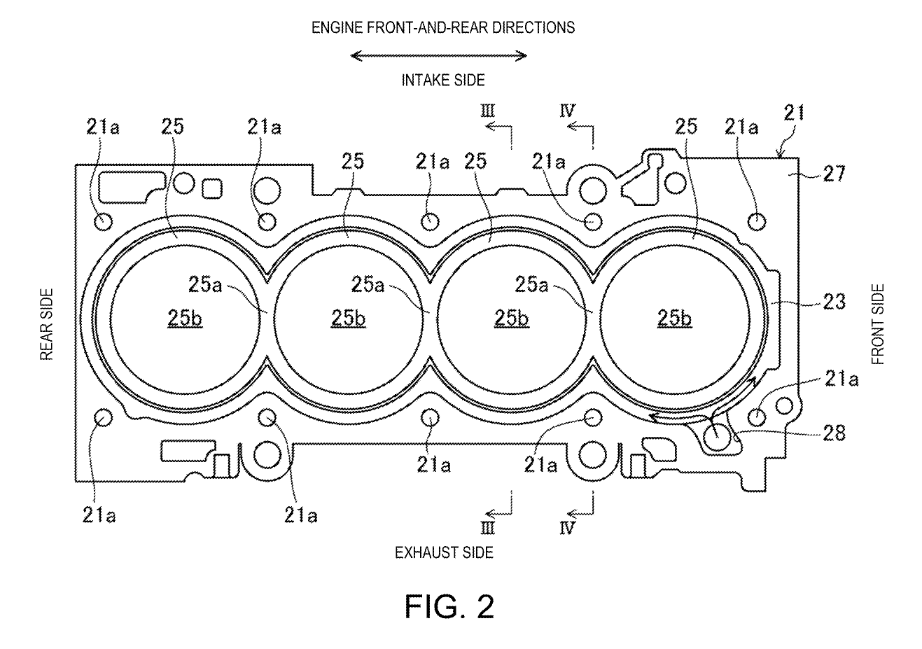

FIG. 2 is a plan view of the cylinder block 21. The engine 2 is transversely placed inside an engine room formed in a front part of the vehicle so that the crankshaft extends in vehicle width directions. A non-illustrated intake manifold for introducing intake air into the respective cylinders 25 is disposed on the left side of the engine 2 (upper side in FIG. 2), and a non-illustrated exhaust system (e.g., an exhaust manifold) is provided on the right side of the engine 2 (lower side in FIG. 2). Bolt holes 21a into which bolts are fitted to fasten the cylinder head 22 to the cylinder block 21 are formed in both end portions of the cylinder block 21 in its longitudinal directions (cylinder-aligning directions, and hereinafter, may also be referred to as the engine front-and-read directions) and also at intake-side and exhaust-side positions of inter-cylinder bore portions 25a.

The water jacket 23 of the cylinder block 21 surrounds an outer circumference of the four cylinders 25 to be formed throughout the cylinder block 21 in the engine front-and-rear directions, and is slightly curved toward the center of the engine in engine left-and-right directions (direction perpendicular to the front-and-rear directions) at positions corresponding to the inter-cylinder bore portions 25a. Moreover, a cooling water inlet path 28 (coolant inlet part) for introducing the cooling water supplied from the water pump 51 into the water jacket 23 is formed in an exhaust-side engine front end part of a cylinder block outer circumferential wall 27 forming the outer circumference of the water jacket 23. The cooling water inlet path 28 is formed at a position of the cylinder block outer circumferential wall 27 corresponding to a lower section of the water jacket 23 and inclines engine rearward as it approaches the cylinder 25 located closest to the front of the engine among all the cylinders 25 (hereinafter, the cylinders 25 located closest to the front and rear of the engine may be referred to as the front and rear cylinders 25, respectively). Therefore, the cooling water introduced into the lower section of the water jacket 23 from the cooling water inlet path 28 is branched engine forward and rearward. A major part of the cooling water flows engine rearward, and the rest of the cooling water flows engine forward.

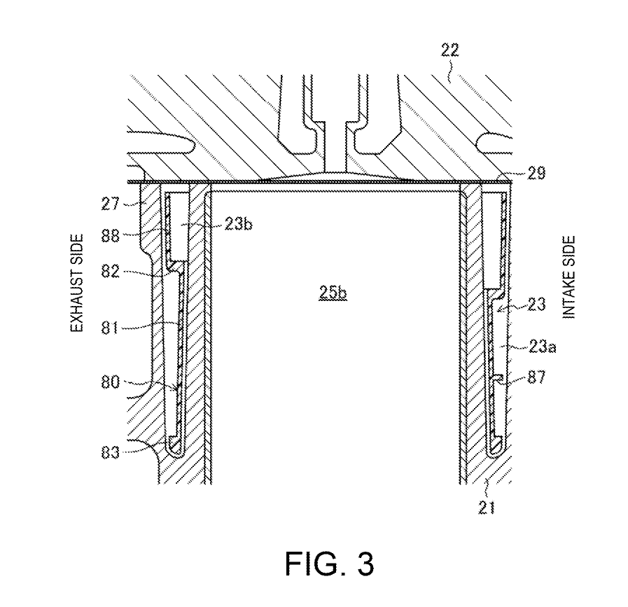

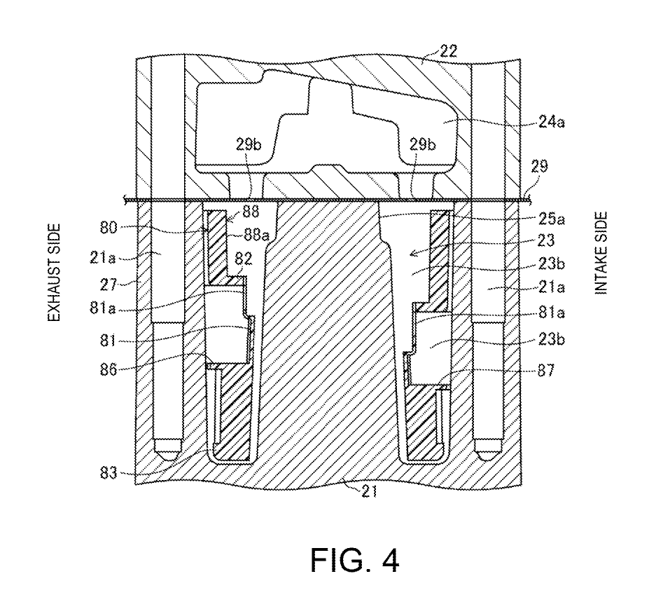

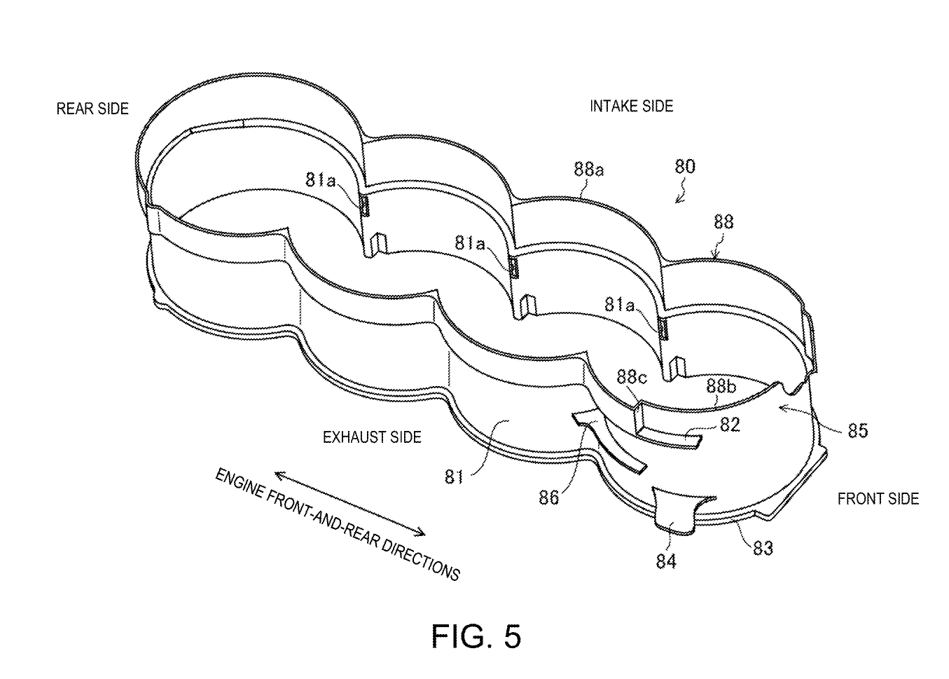

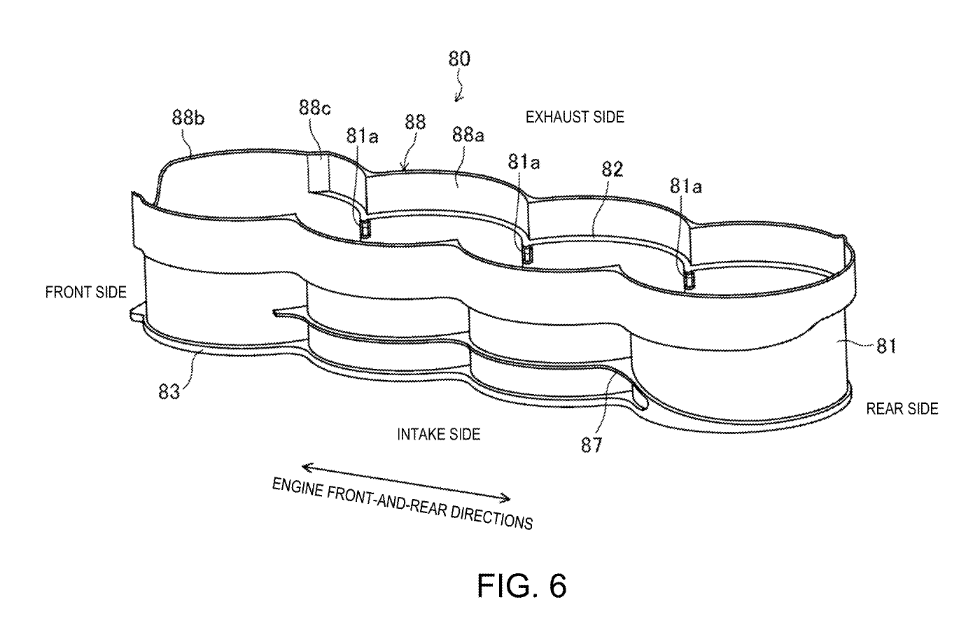

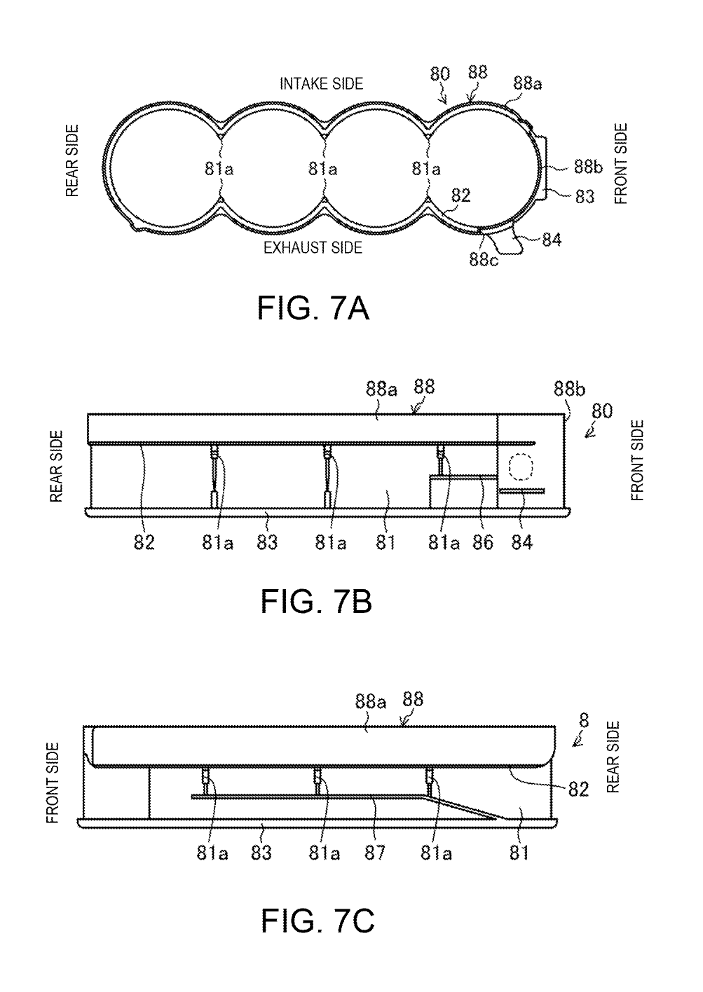

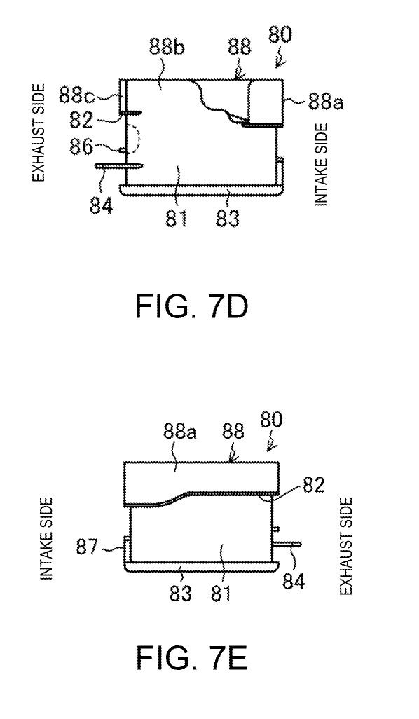

The water jacket 23 of the cylinder block 21 is disposed with a jacket spacer 80 (convection suppressor) forming a path of the cooling water within the water jacket 23. FIGS. 3 and 4 are cross-sectional views of the engine main body 20 in which the jacket spacer 80 is disposed in the water jacket 23, taken along a line III-III and a line IV-IV in FIG. 2, respectively. Moreover, FIGS. 5 and 6 are overall perspective views of the jacket spacer 80 seen from the exhaust and intake sides, respectively. Further, FIG. 7A is a plan view of the jacket spacer 80, FIG. 7B is a side view of the jacket spacer 80 seen from the exhaust side, FIG. 7C is a side view of the jacket spacer 80 seen from the intake side, FIG. 7D is a front view of the jacket spacer 80, and FIG. 7E is a rear view of the jacket spacer 80. Note that, in FIGS. 7B and 7D, the position corresponding to the cooling water inlet path 28 is indicated by broken lines.

The jacket spacer 80 is made of heat-resistant synthetic resin. The jacket spacer 80 has a spacer main body 81 disposed in a lower section (substantially lower half in this embodiment) of the water jacket 23. The spacer main body 81 has a substantially cylindrical shape that is narrow in the engine front-and-rear directions, and positions of the spacer main body 81 corresponding to the inter-cylinder bore portions 25a are curved along the outline of the inter-cylinder bore portions 25a. As illustrated in FIGS. 3 and 4, the spacer main body 81 is close to the cylinders 25 and has a slight gap with the cylinders 25. Moreover, the spacer main body 81 is formed longer in height on the exhaust side than the intake side.

A pair of flanges 82 and 83 projecting outward are formed at an upper end and a lower end of the spacer main body 81, respectively. As illustrated in FIGS. 5 and 6, one of the flanges 82 and 83 is located lower than the other (hereinafter, referred to as the lower flange 83); in other words, the flange 83 is formed over the entire circumference of the lower end of the spacer main body 81. As illustrated in FIGS. 3 and 4, the lower flange 83 has substantially the same width (in the right and left directions of FIGS. 3 and 4) as a lower end width of the water jacket 23.

Moreover, at a position of an outer circumferential face of the spacer main body 81 upward of the lower flange 83 and below of the position corresponding to the cooling water inlet path 28, as illustrated in FIGS. 5 and 7B and the like, a guide piece 84 is formed to prevent the cooling water introduced from the cooling water inlet path 28 from reaching below the spacer main body 81 and to guide the introduced cooling water to the engine front-and-rear directions.

On the other hand, one of the flanges 82 and 83 is located higher than the other (hereinafter, referred to as the upper flange); in other words, the flange 82, is formed substantially over the entire circumference of the upper end of the spacer main body 81, and a cutout section 85 (see FIG. 5) is formed in an engine front end portion of the upper flange 82. Specifically, at the upper end of the spacer main body 81, the upper flange 82 is formed, in a clockwise manner in FIG. 7A, from the position corresponding to the cooling water inlet path 28 to immediately before reaching an engine front end portion of the spacer main body 81 on the intake side, and the cutout section 85 is formed, in the clockwise manner, from the engine front end portion to slightly before reaching the position corresponding to the cooling water inlet path 28.

Moreover, as illustrated in FIGS. 3 and 4, the upper flange 82 has the same width as a substantially central section of the water jacket 23 in its up-and-down directions. Therefore, the water jacket 23 is divided into upper and lower sections by the upper flange 82, and a lower cooling water path 23a where the cooling water introduced from the cooling water inlet path 28 flows is formed between the upper and lower flanges 82 and 83.

Further, rectangular openings 81a, narrow in the up-and-down directions, are formed at positions of the spacer main body 81 right beneath the upper flange 82 and corresponding to the inter-cylinder bore portions 25a. Specifically, the openings 81a are formed in an upper end portion of the spacer main body 81 on the exhaust side, at positions corresponding to the inter-cylinder bore portions 25a, respectively. The openings 81a are also formed in the upper end portion of the spacer main body 81 on the intake side, at positions corresponding to the inter-cylinder bore portions 25a, respectively. Note that, in FIG. 5, among all the openings 81a, only the openings 81a on the intake side are illustrated, and the openings 81a on the exhaust side are covered by an exhaust-side portion of a first holding piece 88a (described later). Moreover, in FIG. 6, among all the openings 81a, only the openings 81a on the exhaust side are illustrated, and the openings 81a on the intake side are covered by the intake-side portion of the first holding piece 88a.

Further, as illustrated in FIGS. 5 and 7B, in the engine front end portion of the outer circumference face of the spacer main body 81 on the exhaust side, a protrusion piece 86 extending substantially in parallel to the engine front-and-rear directions is formed to protrude outward. Specifically, between the guide piece 84 and the openings 81a on the exhaust side in terms of height, the protrusion piece 86 extends from an engine rearward position from the position corresponding to the cooling water inlet path 28 to a position below the opening 81a located closest to the front of the engine among the openings 81a on the exhaust side (hereinafter, the openings 81a located closest to the front and rear of the engine may simply be referred to as the front and rear openings 81a, respectively). In consideration of thermal expansion and the like, as illustrated in FIG. 4, a protruding width of the protrusion piece 86 of this embodiment is set to be slightly narrower than that of the substantially central section of the water jacket 23 in its up-and-down directions; however, the protruding width of the protrusion piece 86 is preferably the same as the width of the water jacket 23 so that there is no gap therebetween.

Moreover, as illustrated in FIGS. 6 and 7C, in the outer circumference face of the spacer main body 81 on the intake side, between an engine rear end portion and a slightly forward portion than the center of the outer circumferential face in the engine front-and-rear directions, a guide protrusion part 87 is formed to protrude outward. Specifically, the guide protrusion part 87 extends forward while inclining upward from an intake-side position of the lower flange 83 corresponding to a cylinder bore 25b of the rear cylinder 25 (may simply be referred to as the rear cylinder bore 25b) to a position below the rear opening 81a, and the guide protrusion part 87 further extends forward substantially in parallel to the engine front-and-rear directions to a position below the front opening 81a. In consideration of thermal expansion and the like, as illustrated in FIGS. 3 and 4A, a width of the guide protrusion part 87 of this embodiment is set to be slightly narrower than the water jacket 23; however, the width of the guide protrusion part 87 is preferably the same as the width of the water jacket 23 so that there is no gap therebetween.

A holding piece 88 (vertical wall) for holding the jacket spacer 80 within the water jacket 23 is formed on the upper end of the spacer main body 81. As illustrated in FIGS. 3 and 4, the holding piece 88 extends upward from the upper end of the spacer main body 81, and an end of the holding piece 88 is close to a ceiling surface of the water jacket 23, in other words, a lower surface of a gasket 29 (described later). Therefore, even when the jacket spacer 80 floats with a buoyance force of the cooling water, the holding piece 88 contacts with the lower surface of the gasket 29, and thus, the jacket spacer 80 is held at a predetermined position. Therefore, the spacer main body 81 stays in the lower section of the water jacket 23 and, thus, can always surround the entire circumference of lower sections of the cylinder bores 25b as a whole.

The holding piece 88 includes a first holding piece part 88a formed at an outer circumference of the upper flange 82 and extends, in the clockwise manner in FIG. 7A, from a position above an engine front end portion of the protrusion piece 86 to immediately before reaching an engine front end of the upper flange 82 on the intake side. The holding piece 88 also includes a second holding piece part 88b formed at the upper end of the spacer main body 81 and extends, in the counter-clock manner in FIG. 7A, from a position above an engine front end of the protrusion piece 86 to the engine front end of the spacer main body 81. The holding piece 88 also includes a coupling piece part 88c coupling the end of the second holding piece part 88b on the exhaust side to the end of the first holding piece part 88a on the exhaust side. Further, an upper cooling water path 23b where the cooling water flows in a space between the holding piece 88 and each of the cylinders 25 is formed on the upper side of the upper flange 82.

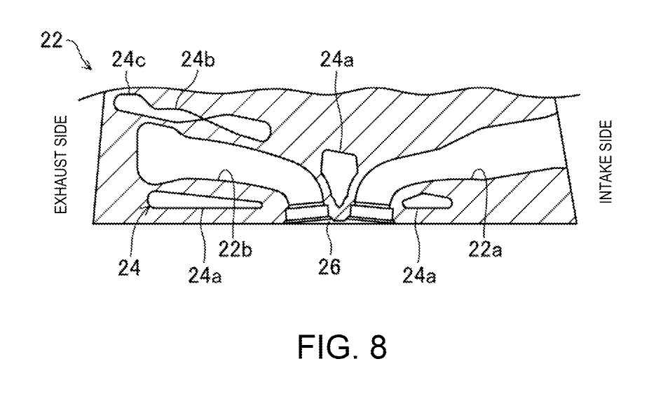

FIG. 8 is a cross-sectional view illustrating a schematic configuration of the cylinder head 22 of the engine 2, and more specifically, it is a view illustrating a cross section of the cylinder head 22, passing, in the engine left-and-right directions, the center of the cylinder bore 25b in the engine front-and-rear directions. The cylinder head 22 includes a substantially cuboid block member, and parts of a bottom face of the cylinder head 22 corresponding to the cylinder bores 25b form ceiling faces of combustion chambers 26, respectively. In an intake-side part of each ceiling face, a pair of intake ports 22a are formed with gaps therebetween in the engine front-and-rear directions, and in an exhaust-side part of the ceiling face, a pair of exhaust ports 22b are formed with gaps therebetween in the engine front-and-rear directions.

The water jacket 24 is formed inside the cylinder head 22. The water jacket 24 includes a main jacket 24a formed around the combustion chambers 26 of the respective cylinders 25, and an exhaust jacket 24b formed on one side of the exhaust ports 22b of the respective cylinders 25 opposite to the combustion chambers 26.

The main jacket 24a is formed near the combustion chambers 26 of the respective cylinders 25 to extend over the entire cylinder head 22 in the engine front-and-rear directions so as to surround the intake and exhaust ports 22a and 22b of the respective cylinders 25 and the outer circumference of plug holes. The main jacket 24a communicates with an outlet path 44 opened to a rear end portion. Moreover, the main jacket 24a also communicates with both end sections of the exhaust jacket 24b in the engine front-and-rear directions, via holes formed at both end sections of the main jacket 24a in the engine front-and-rear directions. Thus, the cooling water flowing inside the main jacket 24a flows into the exhaust jacket 24b.

The exhaust jacket 24b is formed near the exhaust ports 22b of the respective cylinders 25 on the upper side of the exhaust ports 22b to extend over the entire cylinder head 22 in the engine front-and-rear directions. An end section of the exhaust jacket 24b on the exhaust side (outward section of exhaust jacket 24b in its lateral directions) in a cross section and a rear end section of the exhaust jacket 24b are formed to be thicker than other section.

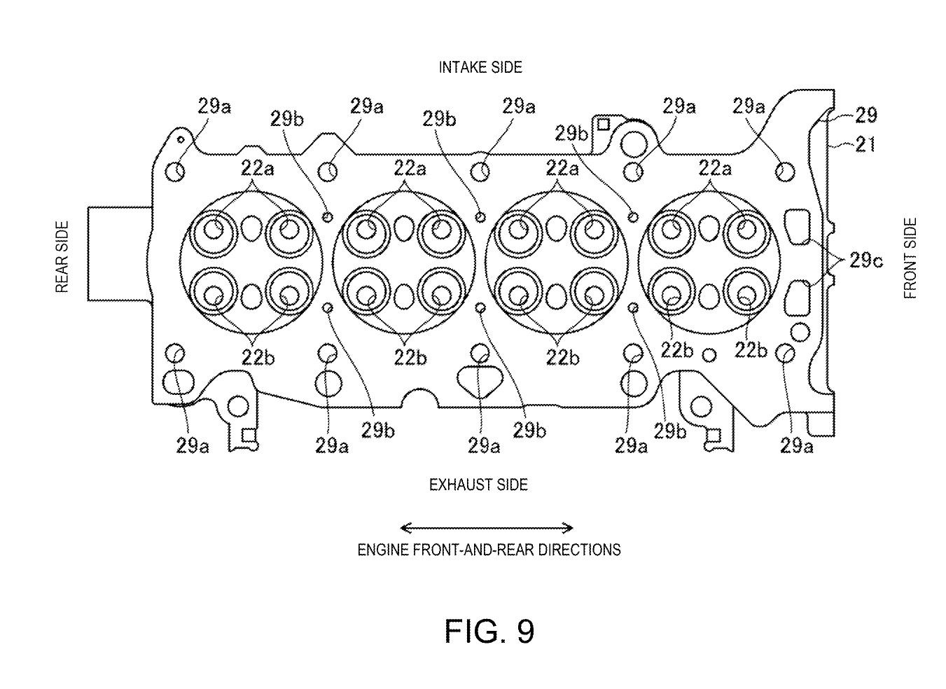

FIG. 9 is a view illustrating the bottom face of the cylinder head 22 with the gasket 29 attached thereto. The gasket 29 is disposed on the bottom face of the cylinder head 22 to cover the main jacket 24a. The gasket 29 is formed with circular penetration holes in portions corresponding to the combustion chambers 26, and bolt insertion penetration holes 29a at positions corresponding to the bolt holes 21a formed in the cylinder block 21.

Further, first communication paths 29b (inter-bore communication passages), each having a circular shape and communicating the water jacket 23 of the cylinder block 21 to the main jacket 24a of the cylinder head 22, are formed to penetrate portions of the gasket 29 corresponding to the inter-cylinder bore portions 25a, and a pair of second communication paths 29c (main communication paths), each having a substantially rectangular shape and communicating the water jacket 23 to the main jacket 24a, are formed to penetrate portions of the gasket 29 corresponding to an engine front end section of the water jacket 23 of the cylinder block 21.

When the water pump 51 supplies the cooling water to the engine main body 20 having the above configuration, the cooling water flows through the water jacket 23 of the cylinder block 21 from the cooling water inlet path 28, and then enters into the main jacket 24a of the cylinder head 22 via the second communication paths 29c of the gasket 29. The cooling water, while flowing through the water jacket 23, enters into the main jacket 24a of the cylinder head 22 via the first communication paths 29b of the gasket 29.

Here, the flow of the cooling water when flowing through the water jacket 23 of the cylinder block 21 is described in detail. The cooling water introduced from the cooling water inlet path 28 first collides against a part of the outer circumferential face of the spacer main body 81 facing the cooling water inlet path 28, and branches toward the front and rear of the engines. Since the cooling water inlet path 28 inclines toward the engine rear approaching the front cylinder 25 as described above, the flow of the cooling water introduced from the cooling water inlet path 28 is oriented toward the engine rear. Therefore, a major part of the cooling water introduced into an exhaust-side section of the water jacket 23 from the cooling water inlet path 28 flows toward the engine rear, and the rest of the cooling water flows toward the engine front.

The cooling water flowing toward the engine front passes around the cylinder bore 25b of the front cylinder 25, then flows through the second communication holes 29c from the cutout section 85 formed in the upper flange 82 of the jacket spacer 80, and then flows into the main jacket 24a of the cylinder head 22.

Meanwhile, the cooling water flowing toward the engine rear is blocked near the cooling water inlet path 28 by the upper flange 82 and the holding piece 88, so that the cooling water does not flow into the upper cooling water path 23b. Therefore, most of the cooling water flows inside the lower cooling water path 23a. The cooling water flowing inside the lower cooling water path 23a is divided upward and downward by the protrusion piece 86 on the engine rear side of the cooling water inlet path 28. Further, since the protrusion piece 86 extends in the engine front-and-rear directions, a rectifying effect that creates a smooth flow in the engine front-and-rear directions can be improved.

Then, the cooling water flowing inside the lower cooling water path 23a reaches the front opening 81a, the part of the cooling water flowing on the upper side of the protrusion piece 86 enters into the front opening 81a, flows inward of the spacer main body 81, and then pulled upward toward the main jacket 24a of the cylinder head 22 where the pressure is low. Here, the cooling water contacts with an upper end region of the corresponding inter-cylinder bore portion 25a near the combustion chambers 26. Therefore, the upper end region of the inter-cylinder bore portion 25a where the temperature easily becomes comparatively high can effectively be cooled.

On the other hand, the cooling water passing on the lower side of the protrusion piece 86 is restricted from flowing into the front opening 81a by the protrusion piece 86, and it flows toward the engine rear. Thus, the entrance into the front opening 81a can be suppressed against the cooling water flowing near the front opening 81a closest to the cooling water inlet path 28 at a high flow speed and a high flow pressure, and the flow rate of the cooling water flowing further downstream can be increased. As a result, the flow rate of the cooling water is substantially equalized among all the openings 81a. Therefore, the inter-cylinder bore portions 25a can be cooled substantially uniformly.

The cooling water passed by the front opening 81a closest to the cooling water inlet path 28 flows inside the exhaust-side section of the water jacket 23, toward the engine rear. While flowing toward the engine rear, a part of the cooling water enters into the opening 81a adjacent to the front opening 81a and the rear opening 81a on the exhaust side, contacts with the respectively corresponding inter-cylinder bore portions 25a to cool them. The cooling water that has passed the inter-cylinder bore portions 25a flows upward to pass through the first communication paths 29b, and enters into the main jacket 24a of the cylinder head 22.

The cooling water that has passed through the exhaust-side section of the water jacket 23 flows around the rear cylinder bore 25b along the rear cylinder bore 25, and further flows inside an intake-side section of the water jacket 23, toward the engine front. Here, although the intake-side potion is far from the cooling water inlet path 28 and the pressure of the cooling water decreases, since the guide protrusion part 87 is formed in the intake-side part of the outer circumference face of the spacer main body 81, the cooling water flows on the upper side of the guide protrusion part 87, and as the flow path cross-sectional area gradually becomes smaller toward the engine front, the flow speed gradually increases. As a result, the cooling water flowing the intake-side section of the water jacket 23 flows into the openings 81a on the intake side at sufficient pressure, similar to the cooling water entering into the openings 81a on the exhaust side.

Then, the cooling water cools, by contacting, the inter-cylinder bore portions 25a corresponding to the openings 81a on the intake side, particularly upper end regions of the inter-cylinder bore portions 25a, flows further upward to pass through the first communication paths 29b, and enters into the main jacket 24a of the cylinder head 22. Therefore, the inter-cylinder bore portions 25a can be cooled from the intake side, as well as from the exhaust side. Therefore, all the inter-cylinder bore portions 25a can be cooled more uniformly.

Moreover, since the guide protrusion part 87 extends in the engine front-and-rear directions, it exerts the rectifying effect that flows the cooling water in the engine front-and-rear directions, similar to the protrusion piece 86. Note that the cooling water flowing on the lower side of the guide protrusion part 87 stagnates on the lower side of the guide protrusion part 87.

Further, the cooling water flowing inside the intake-side section of the water jacket 23 flows around the cylinder bore 25b of the front cylinder 25 (may simply be referred to as the front cylinder bore 25b) along the front cylinder bore 25b, passes through the second communication paths 29c from the cutout section 85 formed in the upper flange 82, and enters into the main jacket 24a of the cylinder head 22.

Note that a part of the cooling water flowed into one of the openings 81a of the jacket spacer 80 does not immediately enter into the main jacket 24a of the cylinder head 22 through the corresponding first communication path 29b, and it gently flows inside the upper cooling water path 23b while partially stagnating. Here, since the portions of the holding piece 88 corresponding to the inter-cylinder bore portions 25a are curved toward the center of the engine in engine left-and-right directions, the cooling water flowing in the upper cooling water path 23b is guided to the inter-cylinder bore portions 25a by the portions of the holding piece 88 corresponding to the inter-cylinder bore portions 25a. Therefore, the cooling water flowing inside the upper cooling water path 23b is also used to cool the inter-cylinder bore portions 25a.

Meanwhile, the cooling water flowing inside the water jacket 23 of the cylinder block 21 has a possibility of causing a convection with the flow formed by water pump 51 or heat transmission from the combustion chambers 26. Due to this convection, the cooling water in the water jacket 23 of the cylinder block 21 enters into the water jacket 24 of the cylinder head 22 and flows therewithin. Thus, there is a risk of cooling the combustion chambers 26 and their peripheries. The jacket spacer 80 suppresses such a convection of the cooling water.

Specifically, the upper flange 82 of the jacket spacer 80 suppresses the entrance into the upper cooling water path 23b near the combustion chambers 26 against the cooling water flowing inside the lower cooling water path 23a on the lower side of the upper flange 82. Moreover, the lower flange 83 suppresses the flow downward of the spacer main body 81 against the cooling water flowing inside the lower cooling water path 23a. Thus, entering inward of the spacer main body 81, in other words, entering between the spacer main body 81 and each of the cylinders 25 is suppressed against the cooling water. Therefore, the convection of the cooling water in the water jacket 23 of the cylinder block 21 is suppressed.

Moreover, the cooling water also flows inside the upper cooling water path 23b while partially stagnating as described above, and since the upper cooling water path 23b is close to the combustion chambers 26, the cooling water is warmed and there is a possibility that convection occurs. Here, a heat transmission rate of liquid by a natural convection within a sealed space is in proportion to the − 1/9th power of a ratio of a height with a width of the sealed space (here, water jacket 23). In other words, as the width becomes narrower, the natural convection is suppressed more and the heat transfer rate becomes lower. Therefore, the holding piece 88 forming the outer circumference of the upper cooling water path 23b is provided so that the width of the upper cooling water path 23b becomes narrower than the water jacket 23, and compared to a case where the holding piece 88 is not provided, convection in the upper cooling water path 23b is suppressed.

The jacket spacer 80 configures a convection suppressor for suppressing the convection of the cooling water from occurring due to the activation of the water pump 51, the cooling water enters into the main jacket 24a from the water jacket 23, and the cooling water flows inside the main jacket 24a.

Thus, the cooling water introduced from the cooling water inlet path 28 flows into the water jacket 23 of the cylinder block 21, enters into the water jacket 24 of the cylinder head 22, and flows to the outlet path 44.

As illustrated in FIG. 1, the outlet path 44 is disposed with a first water temperature sensor 70 for detecting a temperature of the cooling water. The outlet path 44 communicates to second to fourth cooling water passages 41 and 43.

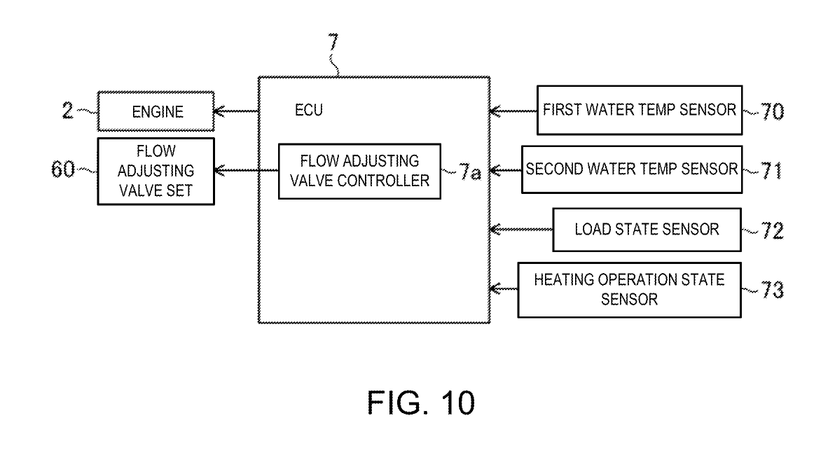

A communication part for the outlet path 44 and the first to fourth cooling water passages 40 to 43 are provided with a flow adjusting valve set 60 for switching the passage through which the cooling water from the outlet path 44 flows. The flow adjusting valve set 60 includes flow rate adjusting valves and/or thermostats which are conventionally well-known. Inside the flow adjusting valve set 60A, a path for the first cooling water passage 40 is independent from a path for the second to fourth cooling water passages 41 to 43. Operation of the flow adjusting valve set 60 is controlled by a flow adjusting valve controller 7a of an engine control unit 7 (circulation system, and hereinafter, referred to as the ECU) illustrated in FIG. 10.

Thereby, the cooling water at comparatively high temperature flowing through the water jacket 24 of the cylinder head 22 flows out to the first to fourth cooling water passages 40 to 43 from the outlet path 44.

An upstream end section of the first cooling water passage 40 communicates to the exhaust jacket 24b via the flow adjusting valve set 60 and the outlet path 44. A downstream end section of the first cooling water passage 40 communicates to the water pump 51 from the intake side. The first cooling water passage 40 is provided with the heater core 30 and a second water temperature sensor 71 for detecting the temperature of the cooling water, in this order from the upstream side. The cooling water flowing through the first cooling water passage 40 warms up air inside the vehicle by exchanging heat in the heater core 30, and then enters into the water pump 51.

The second cooling water passage 41 merges with the fourth cooling water passage 43 at a position downstream of the radiator 37. A downstream end section of the second cooling water passage 41 communicates with the water pump 51 from the intake side. An oil cooler 31 is provided in the second cooling water passage 41 upstream of the merging position with the fourth cooling water passage 43. The cooling water at comparatively high temperature flowing through the second cooling water passage 41 exchanges heat with the oil in the oil cooler 31 and then is returned back to the intake side of the water pump 51.

The third cooling water passage 42 merges with the fourth cooling water passage 43 at a position downstream of the radiator 37 and upstream of the merging position of the second and fourth cooling water passages 41 and 43. An upstream end section of the third cooling water passage 42 communicates with the second cooling water passage 41 at a position upstream of the oil cooler 31, in other words, between the flow adjusting valve set 60 and the oil cooler 31. A downstream end section of the third cooling water passage 42 communicates with the water pump 51 from the intake side. The EGR cooler 33 and the EGR valve 34, and the ATF warmer 32 are provided in the third cooling water passage 42 upstream of the merging position with the fourth cooling water passage 43, in this order from the upstream side. The EGR cooler 33 and the EGR valve 34 are arranged in parallel to each other in the third cooling water passage 42. A part of the cooling water at comparatively high temperature flowing through the third cooling water passage 42 cools the exhaust gas in the EGR cooler 33 by exchanging heat, and the other part of the cooling water exchanges heat with the EGR valve 34. Then, the cooling water exchanges heat with ATF in the ATF warmer 32 and is returned back to the intake side of the water pump 51.

A downstream end section of the fourth cooling water passage 43 communicates with the water pump 51 from the intake side. The fourth cooling water passage 43 is provided with the radiator 37. The cooling water at comparatively high temperature flowing through the fourth cooling water passage 43 is cooled by exchanging heat with outdoor air in the radiator 37 and is returned back to the intake side of the water pump 51.

The water pump 51 is a conventionally well-known centrifugal type in which the cooling water is sent out by, for example, rotation of an impeller, and a shaft of the impeller is operated by the rotation of the crankshaft of the engine main body 20.

The ECU 7, as well-known, includes a CPU, a memory, an I/O interface circuit, a driver circuit, and performs a fuel injection control and an ignition timing control for every cylinder 25 so as to control the operation of the engine 2. Additionally, the ECU 7 controls the operation of the flow adjusting valve set 60 according to states of the wall temperature of each combustion chamber 26 and a heating operation, etc.

In other words, as illustrated in FIG. 10, the ECU 7 at least receives a signal from a load state sensor 72 (e.g., an acceleration opening sensor and/or an airflow sensor of the vehicle) for detecting a load state of the engine 2, and the ECU 7 determines the engine load state based on the signal. If the engine load is low, the engine 2 performs the CI operation, and if the engine load is high, the engine 2 performs the SI operation. Since the convection of the cooling water in the water jacket 23 of the cylinder block 21 is suppressed by the jacket spacer 80, the wall of the combustion chamber 26 becomes difficult to be cooled, which stimulates the increase of the wall temperature of the combustion chamber 26 in an early stage, and the compression self-ignition combustion can be stabilized in the early stage and maintained. As a result, a CI operating range can be extended and fuel consumption can be improved.

Moreover, the ECU 7 at least receives the signal from the first water temperature sensor 70 and a signal from a heating operation state sensor 73 (e.g., a sensor for detecting on and off states of a heating operation switch) for detecting the heating operation state, determines the states of the wall temperature of the combustion chamber 26 and the heating operation, and controls the operation of the flow adjusting valve set 60 according to the determination result.

An overall flow of the cooling water in the engine cooling device 1 configured as above is schematically illustrated in FIG. 1, which illustrates the flow when the flow adjusting valve set 60 closes the first to fourth cooling water passages 40 to 43. Here, the flow of the cooling water hardly occurs in the water jackets 23 and 24 within the engine main body 20. Although the convection of the cooling water may occur in the water jacket 23 of the cylinder block 21 by the combustion of the combustion chamber 26, as described above, the convection of the cooling water in the water jacket 23 is suppressed by the jacket spacer 80. Therefore, the entrance into the main jacket 24a of the cylinder head 22 is suppressed against the cooling water from the water jacket 23 of the cylinder block 21, and the flow of the cooling water hardly occurs in the main jacket 24a. As a result, it is difficult to cool the combustion chamber 26 and its periphery.

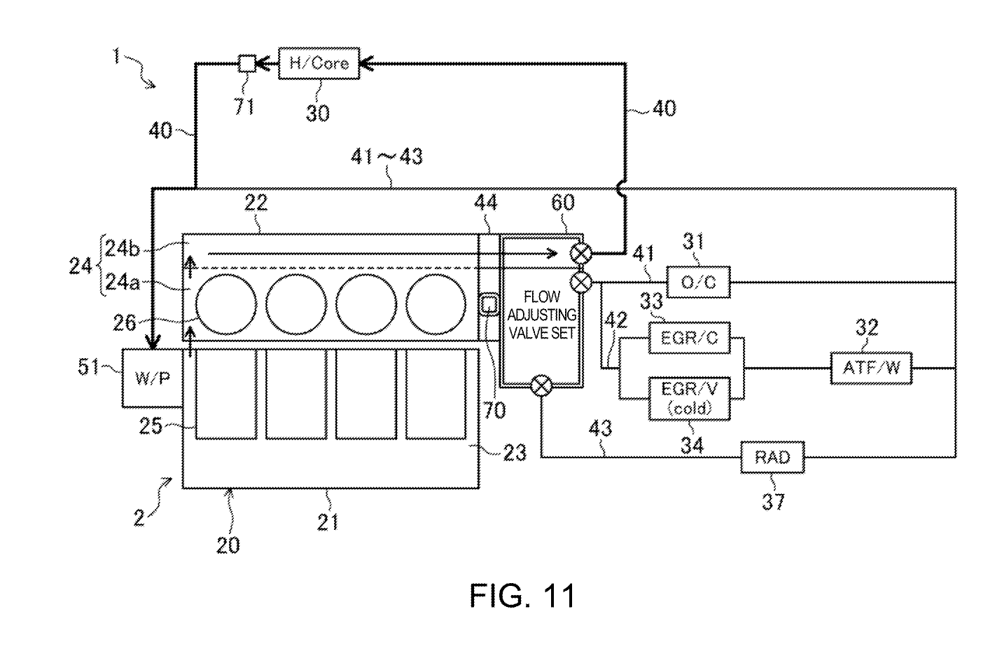

On the other hand, when the flow adjusting valve set 60 closes the second to fourth cooling water passages 41 to 43 and opens the first cooling water passage 40, as illustrated in FIG. 11, the cooling water sent from the water pump 51 to the cooling water inlet path 28 formed in the cylinder block 21 passes, from the water jacket 23 of the cylinder block 21, the engine front section of the main jacket 24a of the cylinder head 22 via the second communication paths 29c without passing through the first communication paths 29b, and then the cooling water enters into the exhaust jacket 24b. Therefore, the cooling water enters into the exhaust jacket 24b mostly without flowing inside the water jacket 23 of the cylinder block 21 and the main jacket 24a of the cylinder head 22. Note that, there is a possibility that this flow of the cooling water pulls (influences) the cooling water inside the water jacket 23 of the cylinder block 21 to cause convection, the jacket spacer 80 disposed in the water jacket 23 suppresses such a convection. Then, the cooling water flows through the exhaust jacket 24b, passes through the outlet path 44, flows inside the first cooling water passage 40, and then is returned back to the intake side of the water pump 50. Here, the cooling water performs the heat exchange through the heater core 30.

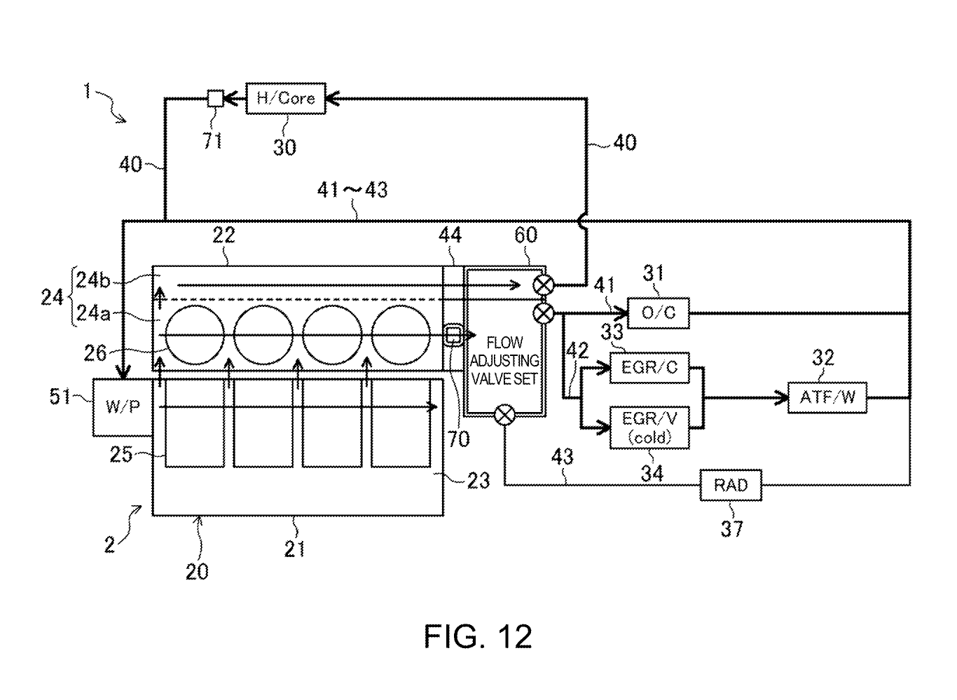

Moreover, when the flow adjusting valve set 60 also opens the second and third cooling water passages 41 and 42 and leaves the fourth cooling water path 43 closed, as illustrated in FIG. 12, the cooling water sent from the water pump 51 to the cooling water inlet path 28 formed in the cylinder block 21 passes, from the water jacket 23 of the cylinder block 21, the first communication paths 29b and the second communication paths 29c, and then enters into the main jacket 24a of the cylinder head 22. Also here, the convection of the cooling water inside the water jacket 23 of the cylinder block 21 is suppressed by the jacket spacer 80. Then, the cooling water flows through the exhaust jacket 24b from the main jacket 24a, further passes through the outlet path 44, flows through the second and third cooling water paths 41 and 42, and is returned back to the intake side of the water pump 51. Here, the cooling water flows through the oil cooler 31, the EGR cooler 33, the EGR valve 34, and the ATF warmer 32, whereas it does not flow through the radiator 37. Further, when the flow adjusting valve set 60 opens the first cooling water passage 40, the cooling water performs the heat exchange through the heater core 30 similar to the above description.

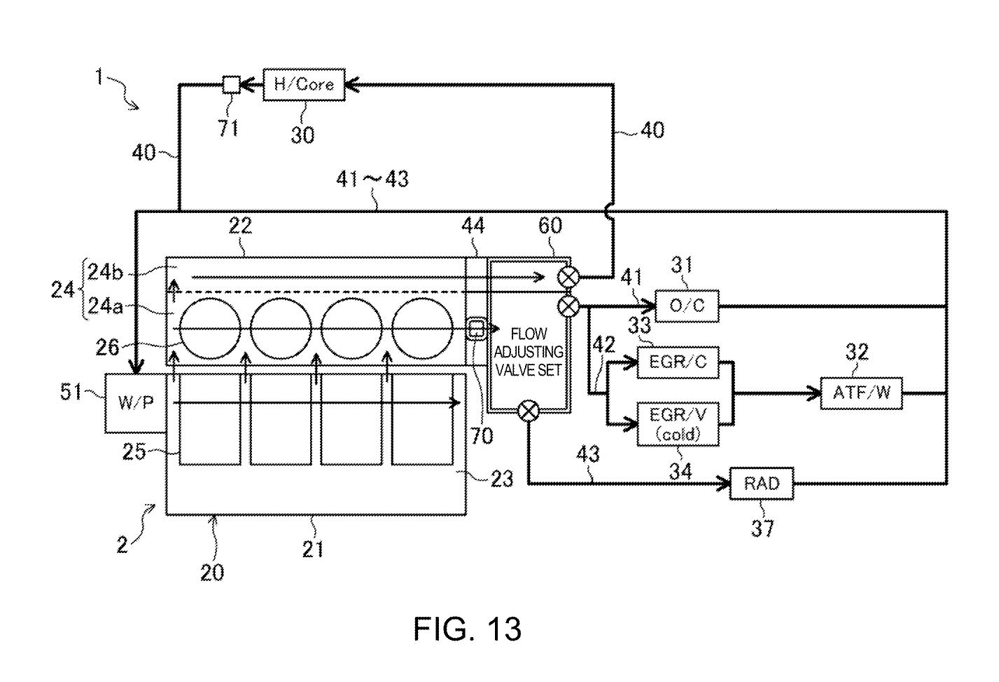

Moreover, when the flow adjusting valve set 60 opens the first to fourth cooling water passages 40 to 43, as illustrated in FIG. 13, the cooling water sent from the water pump 51 to the cooling water inlet path 28 formed inside the cylinder block 21 flows to the water jacket 24 of the cylinder head 22 similar to the above description, further flows through the second to fourth cooling water passages 41 to 43, and is returned back to the intake side of the water pump 51. Here, the cooling water flows through the oil cooler 31, the EGR cooler 33, the EGR valve 34, the ATF warmer 32, and the radiator 37. Further, when the flow adjusting valve set 60 opens the first cooling water passage 40, the cooling water performs the heat exchange through the heater core 30 similar to the above description.

As described above, the flow adjusting valve set 60 opens the second and third cooling water passages 41 and 42 and then the fourth cooling water passage 43 in this order, as the cooling water temperature increases.

### <Operation Control of Flow Adjusting Valve Set>

Next, the operation control of the engine 2 and the flow adjusting valve set 60 by the ECU 7 after the engine start is described.

In an engine cold start (while warming up the engine), when the cooling water temperature is lower than a first target water temperature (e.g., 80° C.) and the heating operation is stopped (when the heating operation is not requested), the engine 2 performs the SI operation and operates the flow adjusting valve set 60 to close the first to fourth cooling water passages 40 to 43. In this manner, the flow of the cooling water inside the water jackets 23 and 24 within the engine main body 20, particularly the convection of the cooling water in the water jacket 23 of the cylinder block 21, is suppressed by the jacket spacer 80, and the wall of the combustion chamber 26 becomes difficult to be cooled, which stimulates the increase of the wall temperature of the combustion chamber 26 in the early stage.

On the other hand, in the engine cold start, when the cooling water temperature is lower than the first target water temperature and the heating operation is performed (when the heating operation is requested), the engine 2 performs the SI operation and operates the flow adjusting valve set 60 to open the first cooling water passage 40 and close the second to fourth cooling water passages 41 to 43. In this manner, the cooling water flows inside the water jackets 23 and 24 of the cylinder block 21 and the cylinder head 22. Here, the cooling water is uniformly supplied to the sections corresponding to the inter-cylinder bore portions 25a, and the inter-cylinder bore portions 25a are uniformly cooled. Further, the convection of the cooling water in the water jacket 23 of the cylinder block 21 is suppressed by the jacket spacer 80, and the flow of the cooling water inside the main jacket 24a of the cylinder head 22 is suppressed. As a result, the increase of the wall temperature of the combustion chamber 26 in the early stage is stimulated. Then, the cooling water flows through the heater core 30 and the inside of the vehicle is warmed up.

Note that, during the heating operation, the flow adjusting valve set 60 is operated to limit the flow rate of the cooling water as a speed of the engine 2 increases. Thereby, a heat amount of the cooling water flowing inside the first cooling water passage 40 per unit flow rate increases. A part of the heat of the cooling water is not exchanged and only circulates through the first cooling water passage 40, which leads to undesirable extra work for the water pump. Therefore, even if the flow rate of the cooling water flowing inside the first cooling water passage 40 is limited according to the engine speed increase, the heat amount satisfying the heating operation request can be supplied to the heater core 30, and the heater performance can be secured. Therefore, by using the flow adjusting valve set 60 to limit the flow rate of the cooling water flowing inside the first cooling water passage 40 according to the engine speed increase during the heating operation, the workload of the water pump 51 for circulating the cooling water can be suppressed while assuring the performance of the heater, and the operation load of the engine 2 used to operate the water pump 51 can be reduced.

Moreover, in the engine cold start, when the cooling water temperature is the first target water temperature or higher, the wall temperature of the combustion chamber 26 is considered to be higher than a target wall temperature (predetermined temperature), and as illustrated in FIG. 12, the engine operating state is switched from the SI operation into the CI operation, and the flow adjusting valve set 60 is operated to open the second and third cooling water passages 41 and 42 and close the fourth cooling water passage 43. In this manner, the cooling water flows through the water jackets 23 and 24 within the engine main body 20. Further, the cooling water flows through the EGR cooler 33, the EGR valve 34, and the ATF warmer 32, cools the exhaust gas in the EGR cooler 33 by exchanging heat, and also exchanges heat with the EGR valve 34. Then, the cooling water further exchanges heat with the ATF in the ATF warmer 32. Moreover, during the heating operation, the cooling water flows through the heater core 30, and the inside of the vehicle is warmed up.

Furthermore, after the engine 2 is warmed up, when the cooling water temperature becomes higher than a second target water temperature that is higher than the first target temperature, a release of heat from the engine 2 is considered to be requested, and the flow adjusting valve set 60 is operated to open the second to fourth cooling water passages 41 to 43, as illustrated in FIG. 13. In this manner, the cooling water flows through the water jackets 23 and 24 within the engine main body 20 similar to the description above. Further, the cooling water flows through the EGR cooler 33, the EGR valve 34, and the ATF warmer 32 similar to the description above. The cooling water also flows through the radiator 37, and the cooling water is cooled by exchanging heat with the outdoor air in the radiator 37. Additionally, during the heating operation, the cooling water flows through the heater core 30 similar to the description above.

Note that, also after the engine 2 is warmed up, the cooling water inside the water jacket 23 of the cylinder block 21 passes through the openings 81a of the jacket spacer 80, contacts with the inter-cylinder bore portions 25a, flows upward to pass through the first communication paths 29b, and enters into the main jacket 24a of the cylinder head 22. Therefore, even after the warming up is completed, the inter-cylinder bore portions 25a can be cooled.

### OTHER EMBODIMENTS

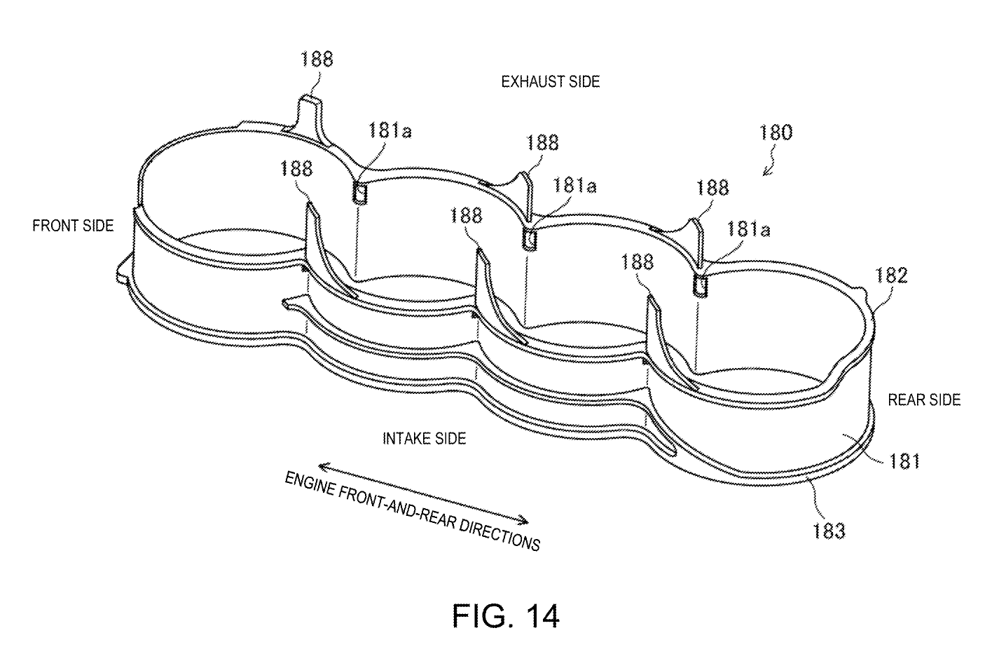

In the above embodiment, the holding piece 88 of the jacket spacer 80 is formed substantially over the entire circumference of the upper flange 82; however, not limited to this embodiment, like a jacket spacer 180 in FIG. 14, it may also be formed only at positions of an upper flange 182 corresponding to the inter-cylinder bore portions 25a. Specifically, from positions of the upper flange 182 corresponding to the respective inter-cylinder bore portions 25a toward the upstream side, holding pieces 188 are formed to curve along an outer circumferential end of the upper flange 182. Further, when the cooling water flowing inside the upper cooling water path 23b approaches the inter-cylinder bore portions 25a, it is guided to the inter-cylinder bore portions 25a by the holding pieces 188. Then, the guided cooling water contacts with the inter-cylinder bore portions 25a, flows upward to pass through the first communication paths 29b, and enters into the main jacket 24a of the cylinder head 22. Note that the holding pieces 188 are not formed over the entire outer circumference of the upper flange 182, and the effect that suppresses the convection of the cooling water flowing inside the upper cooling water path 23b becomes less compared to the above embodiment. Therefore, in view of the convection suppression, the holding piece 88 is preferably formed over the entire outer circumference of the upper flange 82, as the jacket spacer 80 of the above embodiment.

Moreover, in the above embodiment, the convection suppressor includes the jacket spacer 80 disposed in the water jacket 23 of the cylinder block 21; however, not limited to this embodiment, it may also be any configuration as long as it can suppress the convection of the cooling water in the water jacket 23.

As described above, the cooling structure of the multi-cylinder engine according to the present invention can be applied to various applications, such as cooling a plurality of inter-cylinder bore portions.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

### DESCRIPTION OF REFERENCE CHARACTERS

1 Engine Cooling Device (Cooling Device of Multi-cylinder Engine)
2 Engine (Multi-cylinder Engine)
7 ECU (Circulation System)
25 Cylinder
25b Cylinder Bore
21 Cylinder Block
22 Cylinder Head
23 Water Jacket of Cylinder Block
24 Water Jacket of Cylinder Head
24a Main Jacket
24b Exhaust Jacket (Circulation System)
27 Cylinder Block Outer Circumferential Wall
28 Cooling Water Inlet Path (Coolant Inlet Part)
29b First Communication Path (Inter-Bore Communication Passage)
29c Second Communication Path (Main Communication Path)
30 Heater Core (Circulation System)
40 First Cooling Water Passage (Circulation System, Coolant Circuit)
51 Water Pump (Circulation System)
60 Flow Adjusting Valve Set
80 Jacket Spacer (Convection Suppressor)
81 Spacer Main Body
81a Opening
82 Upper Flange
83 Lower Flange
85 Cutout Section
88 Holding Piece (Vertical Wall)

What is claimed is:

1. A cooling device of a multi-cylinder engine including a cylinder head and a cylinder block, the cooling device circulating a coolant from a water pump through a water jacket of the cylinder head and a water jacket of the cylinder block, the cooling device comprising:
a main jacket of the water jacket of the cylinder head, formed around combustion chambers of the engine;
an exhaust jacket of the water jacket of the cylinder head, communicating to the main jacket and formed on an opposite side of exhaust ports to the combustion chambers;
a circulation system for suppressing the coolant from flowing through the main jacket in an engine cold start, by circulating the coolant through the water pump and the exhaust jacket; and
a convection suppressor for suppressing the coolant from flowing into the main jacket from the water jacket of the cylinder block in the engine cold start, by suppressing occurrence of a convection of the coolant inside the water jacket of the cylinder block.

2. The device of claim 1, wherein a coolant inlet part for introducing the coolant into a lower section of the water jacket is formed in a cylinder block outer circumferential wall forming an outer circumference of the water jacket of the cylinder block,
wherein the convection suppressor includes a jacket spacer disposed in the water jacket of the cylinder block,
wherein the jacket spacer has:
a spacer main body disposed in the water jacket of the cylinder block and surrounding all circumferences of lower sections of a plurality of cylinder bores as a whole;
a pair of flanges protruding outward from both upper and lower ends of the spacer main body, respectively; and
a vertical wall extending upward from an outer circumferential end of one of the pair of flanges located higher than the other, and
wherein a cutout section is formed at a position of the upper flange near the coolant inlet part, and main communication paths communicating the water jacket of the cylinder block to the main jacket are formed above the cutout section.

3. The device of claim 2, wherein openings are formed at positions of an upper end portion of the spacer main body corresponding to inter-cylinder bore portions, respectively, and
wherein an inter-bore communication passage communicating the water jacket of the cylinder block to the main jacket is formed above each of the openings.

4. The device of claim 1, wherein the water pump, the exhaust jacket, and a heat exchanger for heater are provided in a coolant circuit for circulating the coolant through the water pump and the exhaust jacket, and the circulation system includes the coolant circuit, and the water pump, the exhaust jacket, and the heat exchanger for heater.

5. The device of claim 2, wherein the water pump, the exhaust jacket, and a heat exchanger for heater are provided in a coolant circuit for circulating the coolant through the water pump and the exhaust jacket, and the circulation system includes the coolant circuit, and the water pump, the exhaust jacket, and the heat exchanger for heater.

6. The device of claim 3, wherein the water pump, the exhaust jacket, and a heat exchanger for heater are provided in a coolant circuit for circulating the coolant through the water pump and the exhaust jacket, and the circulation system includes the coolant circuit, and the water pump, the exhaust jacket, and the heat exchanger for heater.

7. The device of claim 4, wherein the water pump is operated by the multi-cylinder engine, and
wherein the circulation system also includes a flow adjusting valve set for limiting a flow rate of the coolant as an engine speed increases when a heating operation is requested.

8. The device of claim 5, wherein the water pump is operated by the multi-cylinder engine, and
wherein the circulation system also includes a flow adjusting valve set for limiting a flow rate of the coolant as an engine speed increases when a heating operation is requested.

9. The device of claim 6, wherein the water pump is operated by the multi-cylinder engine, and
wherein the circulation system also includes a flow adjusting valve set for limiting a flow rate of the coolant as an engine speed increases when a heating operation is requested.

10. The device of claim 1, wherein the multi-cylinder engine is a spark-ignition engine in which a compression self-ignition combustion operation is performed when an engine load is low, and a spark-ignition combustion operation is performed when the engine load is high.

11. The device of claim 2, wherein the multi-cylinder engine is a spark-ignition engine in which a compression self-ignition combustion operation is performed when an engine load is low, and a spark-ignition combustion operation is performed when the engine load is high.

12. The device of claim 3, wherein the multi-cylinder engine is a spark-ignition engine in which a compression self-ignition combustion operation is performed when an engine load is low, and a spark-ignition combustion operation is performed when the engine load is high.

13. The device of claim 4, wherein the multi-cylinder engine is a spark-ignition engine in which a compression self-ignition combustion operation is performed when an engine load is low, and a spark-ignition combustion operation is performed when the engine load is high.

14. The device of claim 5, wherein the multi-cylinder engine is a spark-ignition engine in which a compression self-ignition combustion operation is performed when an engine load is low, and a spark-ignition combustion operation is performed when the engine load is high.

15. The device of claim 6, wherein the multi-cylinder engine is a spark-ignition engine in which a compression self-ignition combustion operation is performed when an engine load is low, and a spark-ignition combustion operation is performed when the engine load is high.

16. The device of claim 7, wherein the multi-cylinder engine is a spark-ignition engine in which a compression self-ignition combustion operation is performed when an engine load is low, and a spark-ignition combustion operation is performed when the engine load is high.

17. The device of claim 8, wherein the multi-cylinder engine is a spark-ignition engine in which a compression self-ignition combustion operation is performed when an engine load is low, and a spark-ignition combustion operation is performed when the engine load is high.

18. The device of claim 9, wherein the multi-cylinder engine is a spark-ignition engine in which a compression self-ignition combustion operation is performed when an engine load is low, and a spark-ignition combustion operation is performed when the engine load is high.
